(19) United States
(12) Patent Application Publication
(10) Pub. No.: US 2026/0194774 A1
(43) Pub. Date: Jul. 9, 2026

(54) COVER LENS AND A METHOD OF FABRICATING A COVER LENS

(71) Applicants: AUMOVIO Germany GmbH, Frankfurt am Main (DE); Nanyang Technological University, Singapore (SG)

(72) Inventors: Venu Gopal Madhav Annamdas, Singapore (SG); Michael Renaud, Singapore (SG); Leonardus Novianto Depari, Singapore (SG); Thoralf Klingner, Hannover (DE); Shakerzadeh Maziar, Singapore (SG); Syed Ikhwan Syed Ismail Alsagoff, Singapore (SG); Hang Tong Edwin Teo, Singapore (SG)

(73) Assignees: AUMOVIO Germany GmbH, Frankfurt am Main (DE); Nanyang Technological University, Singapore (SG)

(21) Appl. No.: 19/133,579

(22) PCT Filed: Nov. 3, 2023
(86) PCT No.: PCT/EP2023/080638

§ 371 Date: May 28, 2025

(30) Foreign Application Priority Data
Nov. 28, 2022 (GB) 2217775.2

(51) Int. Cl. G02F 1/1333

(52) U.S. Cl. CPC G02F 1/133331; G02F 1/133334; G02F 1/133394

(57) ABSTRACT

A cover lens and a method of fabricating a cover lens is disclosed. The cover lens includes a transparent layer; and a mask provided on a planar surface of the transparent layer, with the mask being electrically conductive.

### TECHNICAL FIELD

The present disclosure relates broadly to a cover lens for a display panel and a method of fabricating a cover lens.

### BACKGROUND

In recent years, display panels have become prevalent in the automotive industry. Automotive vehicles are now commonly equipped with display panels which are configured to display information to the driver/user. The information may include map information, positioning information, vehicle status information etc.

The cover lens of a display panel is the topmost part of a display panel and is the interface between the display panel and the external environment. As such, the cover lens is typically transparent, to allow the image of the LCD to be seen by the user. At the same time, the cover lens is sufficiently rigid and mechanically hardy, such that it can protect the other components of the display panel, beneath the cover lens.

The display panels have become increasingly sophisticated. In addition to merely displaying information, display panels are now also expected to allow a user to interact with the system—such as allowing users to provide inputs via touch sensors, and to provide haptic feedback.

With the increased functionality of the display panel, there is a need to accommodate an increased number of electronic components within the display panel, while maintaining economic competitiveness. Moreover, the increased number of electronic components bring about increased susceptibility to electromagnetic interference from external sources.

In view of the above, there is a need for a cover lens for a display panel and a method of manufacturing a cover lens for a display panel that seek to address or alleviate at least one of the above problems.

### SUMMARY

In a first aspect, there is provided a cover lens for a display panel, said cover lens comprising a transparent layer; and a mask provided on a planar surface of the transparent layer, characterised in that the mask is electrically conductive.

The mask may be opaque to light.

The mask may comprise a bezel provided at a periphery of the transparent layer.

A portion of the bezel may be a first electrode layer for a piezoelectric transducer.

The first electrode layer may comprise a high temperature resilient material.

The first electrode layer may comprise one or more of conductive ceramics, metal-like carbides or nitrides, alumina-based ceramics, zirconia-based materials, silver nanowires and carbon-based conductive materials.

The cover lens may further comprise a piezoelectric layer provided on the first electrode layer; and a second electrode layer provided on the piezoelectric layer, characterised in that the piezoelectric layer is sandwiched between the first electrode layer and the second electrode layer to form the piezoelectric transducer.

The mask may be configured to be electrically grounded.

In a second aspect, there is provided a display panel comprising the cover lens of the first aspect.

In a third aspect, there is provided a method of fabricating a cover lens for a display panel, the method comprising: providing a transparent layer; and forming a mask on a planar surface of the transparent layer; characterised in that the mask is electrically conductive.

In the third aspect, the mask may be opaque to light.

The mask may be printed on the cover lens.

The mask may be a bezel at a periphery of the transparent layer.

A portion of the bezel may be a first electrode layer suitable for a piezoelectric transducer, said first electrode layer comprises a high temperature resilient material.

The method may further comprise forming a piezoelectric layer on the first electrode layer; and forming a second electrode layer on the piezoelectric layer; characterised in that the piezoelectric layer is sandwiched between the first electrode layer and the second electrode layer to form the piezoelectric transducer.

### BRIEF DESCRIPTION OF FIGURES

FIG. 1 shows an exploded view of a display panel, in an example embodiment.

FIG. 2 shows a cross-sectional view of the display panel, when assembled.

FIG. 3 shows an exploded view of a cover lens, in the example embodiment.

FIG. 4 shows a cross-sectional view of a display panel, when assembled, in another example embodiment.

FIG. 5 shows an exploded view of a cover lens, in the other example embodiment.

FIG. 6 illustrates a method for fabricating a cover lens for a display panel.

FIG. 7 is a flow chart illustrating a method for fabricating a cover lens for a display panel.

### DETAILED DESCRIPTION

Example embodiments of the disclosure will be better understood and readily apparent to one of ordinary skill in the art from the following discussions and if applicable, in conjunction with the figures. It should be appreciated that other modifications related to structural, electrical and optical changes may be made without deviating from the scope of the invention. Example embodiments are not necessarily mutually exclusive as some may be combined with one or more embodiments to form new exemplary embodiments. The example embodiments should not be construed as limiting the scope of the disclosure.

Example, non-limiting embodiments may provide a cover lens for a display panel, a display panel and a method of fabricating a cover lens for a display panel.

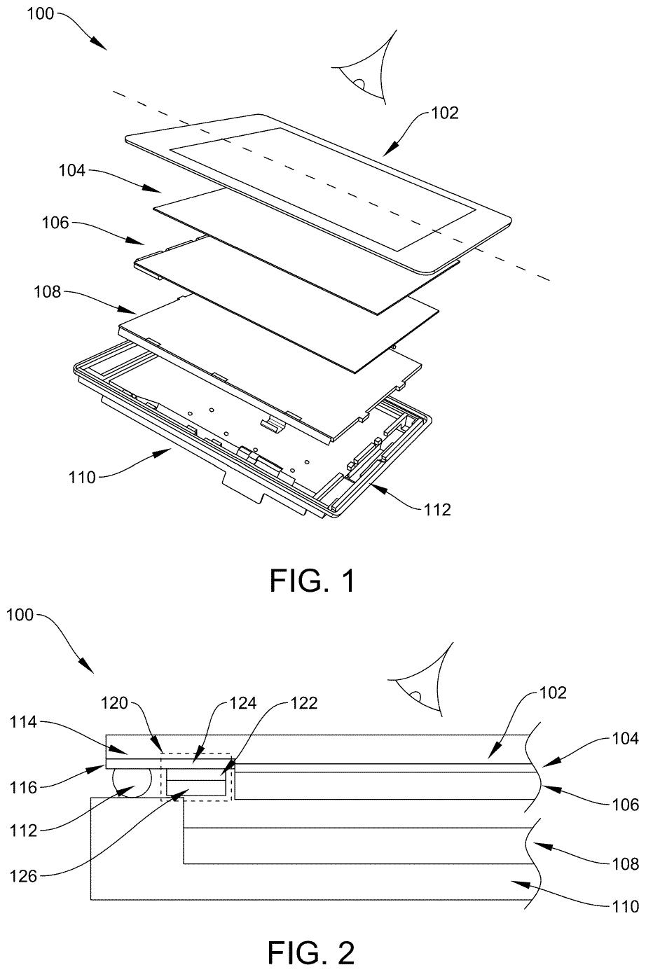

FIG. 1 shows a perspective exploded view of a display panel 100, in an example embodiment. FIG. 2 shows a cross-sectional view of the display panel 100, when assembled.

The display panel 100 comprises a display stack, the display stack comprising a planar cover lens 102, an OCA (Optically Clear Adhesive) layer 104, an LCD and touch sensor layer 106, a backlight and PCB layer 108 and a back cover 110.

The cover lens 102 is at the top of the display stack and is the part of the assembly which is in direct contact with the environment and the user. The OCA layer 104 is sandwiched between the LCD and touch sensor layer 106 and the cover lens 102. The OCA layer 104 adheres the LCD and touch sensor layer 106 onto an internal side/surface of the cover lens 102.

The cover lens 102 comprises a transparent layer 114 (See FIG. 2) made of e.g., tempered glass material, which is substantially transparent to light such that it allows the desired image formed by the LCD display to be seen by the user from above the display panel 100, opposite the internal side of the cover lens 102.

Suitable alternative materials for the transparent layer 114 include Polycarbonate (PC), Acrylic (PMMA), Polyethylene Terephthalate Glycol (PETG).

The cover lens 102 further comprises a bezel 116 provided on the periphery of the internal side/planar surface of the transparent layer. The bezel 116 is substantially opaque to light. Thus, the bezel 116 conceals the electronic components which are positioned under the periphery of the cover lens 102, such that they cannot be seen by the user from above the display panel 100. In the example embodiment, the bezel 116 is realised with or comprises a black mask printed on the bottom/internal planar surface of the cover lens 102.

The back cover 110, comprises a cavity defined by protrusions formed on the periphery of the back cover 110. The cavity is found on an interior side/surface of the back cover 110. The backlight and PCB layer 108 is arranged within the cavity of the back cover 110.

The cover lens 102 and back cover 110 are coupled or bonded together at their peripheral edges to form a substantially cuboid-shaped housing such that the OCA layer 104, LCD and touch sensor layer 106, and backlight and PCB layer 108 are contained within the housing, substantially within the cavity of the back cover 110. The cover lens 102 (together with the back cover) provides protection to the sensitive or fragile components of the display stack, such as the electronic components contained in the LCD and touch sensor layer 106, and backlight and PCB layer 108.

In the example embodiment, the cover lens 102 and back cover 110 are bonded or coupled together by way of a bonding ring 112. The bonding ring 112 is an adhesive or bonding material, arranged on the underside of the bezel 116, and couples the bezel 116 of the cover lens 102, to the back cover 110. In other words, the bonding ring is sandwiched between the bezel 116 (which is on the periphery of the cover lens 102), and the protruded periphery of the back cover 110.

In the example embodiment, the display panel 100 further comprises an electronic component in the form of a piezoelectric transducer 120 (Shown in FIG. 2 only). The piezoelectric transducer 120 can be configured as an actuator to generate vibrations to the cover lens, for providing haptic feedback to a user. The piezoelectric transducer 120 can also be configured as a sensor to produce a voltage when a force is applied on the cover glass. The force may be in the form of vibrations or strains happening on the cover glass. The piezoelectric transducer 120 is coupled to the cover lens 102, on the underside of the cover lens 102, and occupies a portion of the bezel 116. The piezoelectric transducer 120 comprises of a piezoelectric material 122 sandwiched between a first electrode 124 and a second electrode 126. The bezel 116 is electrically conductive and a portion of the bezel 116 is used as one of the electrodes (e.g., first electrode 124) of the piezoelectric transducer 120.

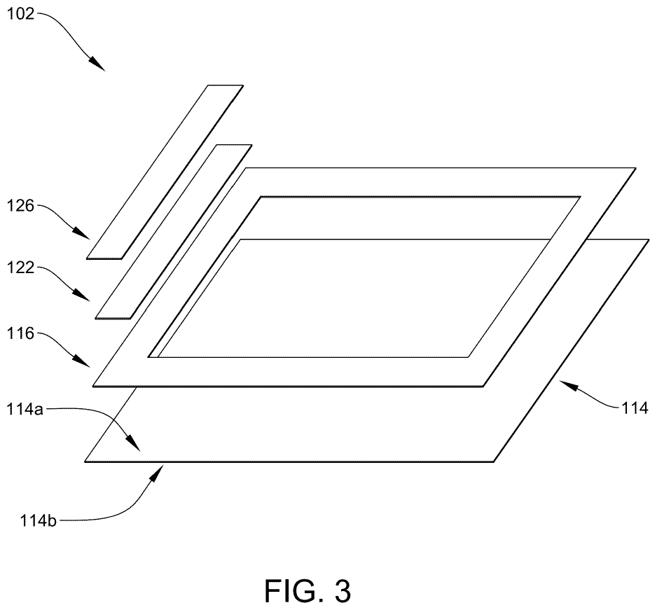

FIG. 3 shows an exploded view of the cover lens 102, in an example embodiment. In contrast with FIG. 1 and FIG. 2, the cover lens 102 shown in FIG. 3 is flipped to now show bottom layer up. The cover lens 102 comprises the transparent layer 114 having an internal planar surface 114a and an external planar surface 114b. The bezel 116 is provided at the periphery of the transparent layer and on the internal planar surface 114a of the transparent layer 114. The bezel 116 is made of an electrically conductive material and is used as a first electrode 124 (FIG. 2) for the piezoelectric transducer 120.

The cover lens 102 further comprises a piezoelectric layer 122 provided on the first electrode 122, such that the bezel (i.e., the first electrode 124) is sandwiched between the transparent layer and the piezoelectric layer 122.

The cover lens 102 further comprises a second electrode layer 126 provided on the piezoelectric layer 122, such that piezoelectric layer 122 is sandwiched between the first electrode layer 124 and second electrode layer 126, to form the piezo electric transducer 120.

The operations of the display panel 100 are electronically controlled by a microcontroller or microprocessor whose circuitry is contained within the PCB layer 108. Electrical connections between the various electronic components and/or layers are not shown in the figures, for ease of understanding the figures.

In the example embodiments described herein, the bezel is substantially opaque to light in order to advantageously conceal the electronic components placed behind the periphery/edges/corners of the cover lens, in the interior of the display panel.

In the example embodiment described above, the piezoelectric transducer is formed using only a portion of bezel as the first electrode. As shown in FIG. 3, the bezel 116 is frames the periphery of the transparent layer and is substantially rectangular in shape. One side of the rectangular bezel is utilised as the first electrode of the piezoelectric transducer.

It will also be appreciated that multiple piezoelectric transducers may be coupled, each piezoelectric transducer using respective different portions of the bezel as respective first electrodes.

Embodiments of the cover lens disclosed herein provide a cost-effective way for incorporating/integrating a piezoelectric transducer into a cover lens for a display panel. The bezel not only serves to conceal the electronic components placed behind the periphery/edges/corners of the cover glass, but it also serves as an electrode for a piezoelectric transducer. In other words, the bezel serves the dual purpose of being a high temperature resilient black mask as well as an electrode to the piezoelectric transducer.

To serve as an electrode for an electrical component such as a piezoelectric transducer, the bezel disclosed herein is made of materials which are electrically conductive and able to withstand high temperatures. The manufacturing of piezoelectric materials involves high temperature steps (such as sintering). Therefore, the electrode comprises a high temperature resilient material that is capable of withstanding the temperatures involved in a sintering process. In the example, the electrode material is capable of withstanding temperatures of 800° C. or more. The piezoelectric print process is a deposit of material composition/compound followed by thermal treatment steps such as sintering to achieve the desired material properties. Example print processes include spraying, dispensing, screen printing, inkjet printing, pad-printing or physical vapor deposition.

Examples of suitable materials for the bezel/electrode are:
conductive ceramics such as metal-like carbides (ZrC, TiC) or nitrides (TiN, TaN), alumina-based ceramics
zirconia-based materials
silver nanowires
carbon-based materials such as graphite and carbon nanotubes
combination of the aforementioned materials in the form of sprays, thin films, suspensions or composites. Non electrically conductive materials acting as matrix or pigment could also be added to the compound.

Examples of unsuitable materials are:
Standard black print materials (acrylic, siloxane, polyimide polymer matrix with colouring pigments) due to their low melting temperature and low electrical conductivity
Standard copper and silver based electrodes materials) due to their low melting temperature

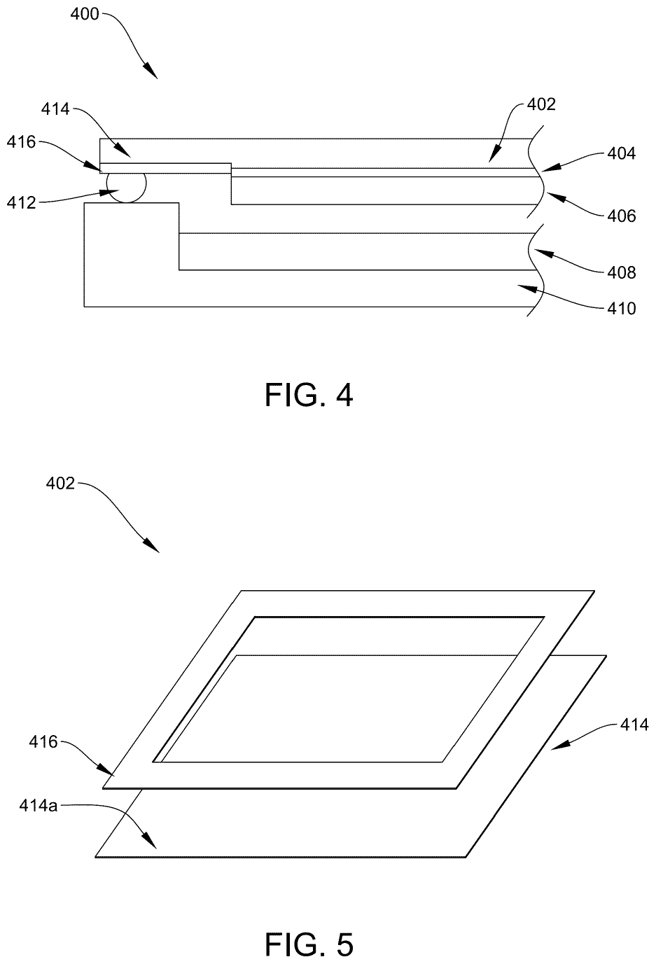

FIG. 4 shows a cross-sectional view of an example embodiment of a display panel 400, when assembled. The embodiment of the display panel 400 is substantially identical to the embodiment of the display panel 100 (FIG. 2), with the exception that instead of the bezel comprising an electrode for an piezoelectric transducer, the bezel comprises an electrode to provide Electromagnetic Compatibility (EMC) Shielding to the electronic components contained in the display panel.

The display panel 400 comprises a display stack, the display stack comprising a planar cover lens 402, an OCA (Optically Clear Adhesive) layer 404, an LCD and touch sensor layer 406, a backlight and PCB layer 408 and a back cover 410.

The cover lens 402 is at the top of the display stack and is the part of the assembly which is in direct contact with the environment and the user. The OCA layer 404 is sandwiched between the LCD and touch sensor layer 406 and the cover lens 402. The OCA layer 404 adheres the LCD and touch sensor layer 406 onto an internal side of the cover lens 402.

The cover lens 402 comprises a transparent layer 414 made of e.g., tempered glass, which is substantially transparent to light. This allows the desired image formed by the LCD display to be seen by the user from above the display panel 400, opposite the internal side of the cover lens 402. Suitable alternative materials for the transparent layer 414 include Polycarbonate (PC), Acrylic (PMMA), Polyethylene Terephthalate Glycol (PETG).

The cover lens 402 further comprises a bezel 416 provided on the periphery of the internal planar surface of the cover lens 402. The bezel 416 is substantially opaque to light. Thus, the bezel 416 can conceal the electronic components which are positioned under the periphery of the cover lens 402, such that they cannot be seen by the user from above the display panel 400. In the example embodiment, the bezel 416 is realised with a black mask printed on the bottom/internal planar surface of the cover lens 402.

The back cover 410, comprises a cavity defined by protrusions formed on the periphery of the back cover 410. The cavity is found on an interior side/surface of the back cover 410. The backlight and PCB layer 408 is arranged within the cavity of the back cover 410.

The cover lens 402 and back cover 410 are coupled or bonded together at their peripheral edges to form a substantially cuboid-shaped housing such that the OCA layer 404, LCD and touch sensor layer 406, and backlight and PCB layer 408 are contained within the housing, substantially within the cavity of the back cover 410. The cover lens 402 (together with the back cover) provides protection to the sensitive or fragile components of the display stack, such as the electronic components contained in the LCD and touch sensor layer 406, and backlight and PCB layer 408.

In the example embodiment, the cover lens 402 and back cover 410 are bonded or coupled together by way of a bonding ring 412. The bonding ring 412 is arranged on the underside of the bezel 416, and couples the bezel 416 of the cover lens 402, to the back cover 410. In other words, the bonding ring is sandwiched between the bezel 416 (which is on the periphery of the cover lens 402), and the protruded periphery of the back cover 410.

In the example embodiment, the bezel 416 is made up of an electrically conductive material, which can be supplied with an input voltage to bias the bezel at a particular voltage potential. In the example embodiment, the bezel is configured to be electrically grounded, such that it acts as an EMC shield for protecting the electronic components contained in the display panel such as the LCD and touch sensor layer 406, and backlight and PCB layer 408, from external electromagnetic signals.

FIG. 5 shows an exploded view of the cover lens 402, in an example embodiment. In contrast with FIG. 4, the cover lens 402 shown in FIG. 5 is flipped or inverted to now show bottom-layer up. The cover lens 402 comprises the transparent layer having an internal planar surface 414a and an external planar surface. The bezel 416 is provided at the periphery of the transparent layer and on the internal planar surface 414a of the transparent layer. The bezel 416 is made of a conductive material that is configured to be electrically grounded, to provide EMC shielding to the electronic components contained in the LCD and touch sensor layer 406, and backlight and PCB layer 408.

In the embodiment illustrated in FIGS. 4 and 5, the bezel/electrode 406 may not be subjected to the same high temperature requirements as the piezoelectric transducer embodiments illustrated in FIGS. 1, 2 and 3, in order to achieve the EMC shielding function. That is, even though good electrical conductivity (e.g., >1*107 S/m) is required, high temperature stability may not be required. Thus, in addition to the materials suitable for the piezoelectric transducer electrode as mentioned above, the following materials can also be used: conductive ink, paints or polymers made of an organic or inorganic solvent or polymer matrix filled with micro or nanoparticles of metal (e.g., gold, silver, platinum, copper, nickel), or intrinsically conducting polymers.

In the example embodiments described herein, the electrically conductive bezel is formed from an opaque mask provided on the periphery of the transparent layer. In alternative embodiments, the mask is not limited to be formed on the periphery of the transparent layer. The electrically conductive mask and may be formed any where on the internal surface of the transparent layer.

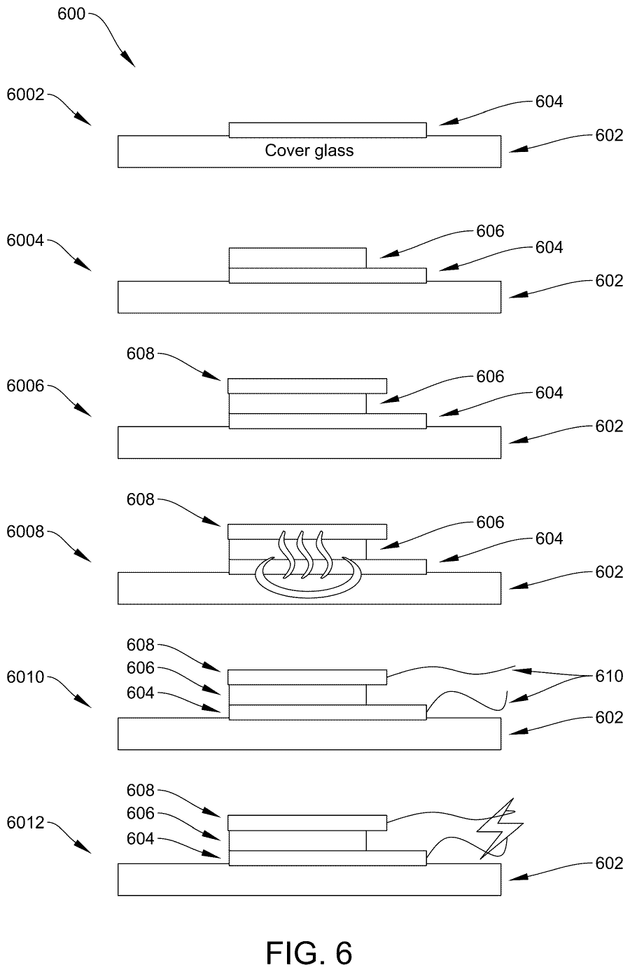

FIG. 6 illustrates a method 600 for fabricating a cover lens for a display panel. At step 6002, a transparent layer 602 e.g., cover glass is provided and an electrically conductive mask 604 is deposited or printed on one e.g., top surface of the transparent layer 602. The mask 604 forms a first electrode of a piezoelectric transducer.

At step 6004, a piezoelectric material 606 is deposited on the first electrode 604, such that the first electrode 604 is sandwiched between the piezoelectric material 606 and the transparent layer 602.

At step 6006, the second electrode layer 608 is deposited on the piezoelectric material 606, such that the piezoelectric material 606 is sandwiched between the first electrode 604 and the second electrode layer 608.

At step 6008, the transparent layer 602, first electrode 604, piezoelectric material 606 and second electrode 608 are sintered together to form a monolithic structure.

At step 6010, after the sintering step 6008, electrical connections which allow the structure to be configured as a piezoelectric transducer, are added to the first electrode 604 and second electrode 608. Thereafter, at step 6012, the piezoelectric transducer is poled to align the polarity of the dipoles, for better sensitivity.

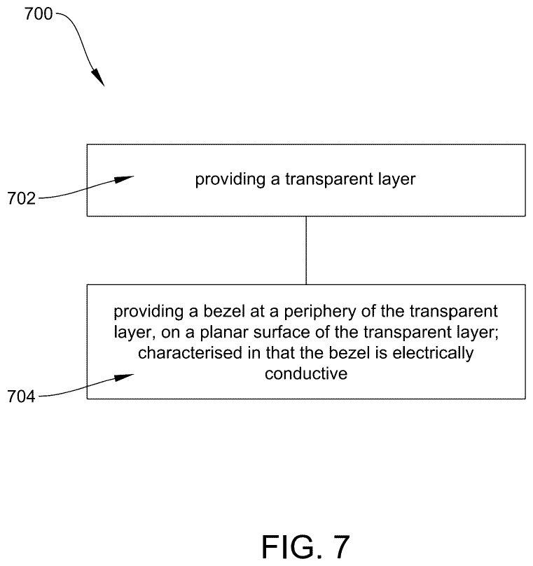

FIG. 7 is a flow chart illustrating a method 700 for fabricating a cover lens for a display panel. At step 702, a transparent layer is provided. At step 704, a mask is formed a surface of the transparent layer, characterised in that the mask is electrically conductive.

In the exemplary method, the mask may be opaque to light. The step of forming the mask on the surface may comprise printing the mask on the cover lens followed by a sintering process.

The mask may be printed at a periphery of the transparent layer to form a bezel. A portion of the bezel may be utilised as a first electrode layer suitable for a piezoelectric transducer, said first electrode layer comprises a high temperature resilient material.

The exemplary method may further comprise forming a piezoelectric layer on the first electrode layer; and forming a second electrode layer on the piezoelectric layer; characterised in that the piezoelectric layer is sandwiched between the first electrode layer and the second electrode layer to form the piezoelectric transducer.

In the described example embodiments, a cover lens for a display panel is disclosed. The cover lens comprises a transparent layer, and a mask provided on a planar surface of the transparent layer, characterised in that the mask is electrically conductive. This allows the mask to be utilised as a part of an electrical component.

In some embodiments, the mask is opaque to light. This conceals the objects hidden behind the mask from being seen through the transparent layer. The mask may also comprise a bezel, said bezel provided at the periphery of the transparent layer. In doing so, the bezel serves the dual purpose of concealing portions of the interior or internal area of the display panel from being seen externally, while being utilised as part of an electrical component, or provide an electrical function.

For example, the electrical component may be a piezoelectric transducer. A portion of the bezel may be a first electrode layer suitable for a piezoelectric layer. The first electrode layer may comprise a high temperature resilient material, that is capable of withstanding the temperatures of a sintering process, in order for the material to be sintered onto the transparent layer. For example, the first electrode layer is to be capable of withstanding temperatures of up to 800 degrees Celsius in order to withstand currently known sintering processes.

The first electrode layer may thus comprise one or more of conductive ceramics, metal-like carbides or nitrides, alumina-based ceramics, zirconia-based materials, silver nanowires and carbon-based conductive materials.

The cover lens may fully comprise the piezoelectric transducer for ease of assembly into the display panel. The cover lens further comprises a piezoelectric layer provided on the first electrode layer, and a second electrode layer formed on the piezoelectric layer, such that the piezoelectric layer is sandwiched between the first electrode layer and the second electrode layer to form the piezoelectric transducer.

The cover lens may comprise multiple piezoelectric transducers. Each piezoelectric transducer may utilise respective different portions of the bezel as respective first electrodes.

The piezoelectric transducer may be a piezoelectric actuator, or a piezoelectric force sensor.

As an alternative to the piezoelectric transducer, the electrically conductive mask may be grounded or configured to be grounded, to provide EMC shielding to the electronic components within the display panel.

Example embodiments described herein are suitable for applications where a cover lens with a bezel or mask is involved. This includes, but is not limited to, the automotive, aerospace, robotics and digital gaming industries, where human machine interfaces such as display units/panels are commonly used.

Example embodiments of the cover lens for a display panel and method of fabricating a display lens as disclosed herein are further described in the following clauses.

Clause 1. A cover lens for a display panel, said cover lens comprising: a transparent layer, and a mask provided on a planar surface of the transparent layer, wherein the bezel is electrically conductive.

Clause 2. The cover lens of clause 1, characterised in that the mask is opaque to light, preventing light from passing through the transparent layer at the sections where the mask is provided.

Clause 3. The cover lens of clauses 1 or 2, characterised in that the mask comprises a bezel provided at a periphery of the transparent layer.

Clause 4. The cover lens of clause 3, characterised in that a portion of the bezel is a first electrode layer for a piezoelectric transducer.

Clause 5. The cover lens of clause 3, characterised in that the bezel in its entirety is a first electrode layer for a piezoelectric transducer.

Clause 6. The cover lens of clause 4, characterised in that the first electrode layer comprises a high temperature resilient material.

Clause 7. The cover lens of clause 4, characterised in that the first electrode layer comprises a material capable of withstanding up to 800 degrees Celsius.

Clause 8. The cover lens of any one of clause 4 to 7, characterised in that the first electrode layer comprises one or more of conductive ceramics, metal-like carbides or nitrides, alumina-based ceramics, zirconia-based materials, silver nanowires and carbon-based conductive materials.

Clause 9. The cover lens of any one of clause 4 to 8, further comprising a piezoelectric layer provided on the first electrode layer, characterised in that the first electrode layer is sandwiched between the piezoelectric layer and the transparent layer.

Clause 10. The cover lens of any one of clause 9, further comprising a second electrode layer provided on the piezoelectric layer, characterised in that the piezoelectric layer is sandwiched between the first electrode layer and the second electrode layer to form the piezoelectric transducer.

Clause 11. The cover lens of any one of clause 4 and 6 to 10, characterised in that another portion of the bezel is another first electrode layer for another piezoelectric transducer.

Clause 12. The cover lens of any one of clauses 1 to 3, characterised in that the mask is configured to be electrically grounded.

Clause 13. The cover lens of any one of the preceding clauses, characterised in that the transparent layer is made of a material that is transparent to light.

Clause 14. The cover lens of any one of the preceding clauses, characterised in that the transparent layer is made of a high temperature resilient material.

Clause 15. The cover lens of any one of the preceding clauses, characterised in that the transparent layer is made of glass.

Clause 16. A display panel comprising the cover lens of any one of the preceding clauses.

Clause 17. The display panel of clause 16, further comprising an LCD arranged under the transparent layer, such that the image produced by the LCD can be seen through the cover lens.

Clause 18. The display panel of clause 16 or 17, further comprising a back cover coupled to the cover lens to form a housing.

Clause 19. The display panel of clause 18, characterised in that other layers of the display panel are contained within the housing.

Clause 20. A method of fabricating a cover lens for a display panel, the method comprising: providing a transparent layer; and forming a mask on a planar surface of the transparent layer; characterised in that the mask is electrically conductive.

Clause 21. The method of clause 20, characterised in that the mask is opaque to light.

Clause 22. The method of clause 20 or 21, characterised in that the mask is printed on the cover lens.

Clause 23. The method of any one of clauses 20 to 22, characterised in that the mask is a bezel at a periphery of the transparent layer.

Clause 24. The method of clause 23, characterised in that a portion of the bezel is a first electrode layer suitable for a piezoelectric transducer, said first electrode layer comprises a high temperature resilient material.

Clause 25. The method of clause 24, further comprising forming a piezoelectric layer on the first electrode layer; and forming a second electrode layer on the piezoelectric layer; characterised in that the piezoelectric layer is sandwiched between the first electrode layer and the second electrode layer to form the piezoelectric transducer.

Clause 26. The method of clause 25, wherein the piezoelectric transducer is formed via sintering of the transparent layer, first electrode layer, piezoelectric layer and second electrode layer.

The term “electrically conductive material” as used herein is to be interpreted broadly to include but not limited to both a conductive material, which is intrinsically or inherently capable of electrical conductivity, and a semiconductive material, which exhibits semiconducting properties. In connection with aspects as described above in the clauses and as described below in the claims, the term “electrically conductive”, and similar terms, may additionally be used to describe a conductive or semiconductive material having a surface resistivity of less than 10⁵ ohms/square at 1 atm and at 20 C (Department of Defense Standards).

The term “layer” when used to describe a first material is to be interpreted broadly to refer to a first depth of the first material that is distinguishable from a second depth of a second material. The first material of the layer may be present as a continuous film, as discontinuous structures or as a mixture of both. The layer may also be of a substantially uniform depth throughout or varying depths. Accordingly, when the layer is formed by individual structures, the dimensions of each of individual structure may be different. The first material and the second material may be same or different and the first depth and second depth may be same or different.

The term “substantially transparent to light” when used herein to describe an object is to be interpreted broadly to mean that 50% or more of the incident light normal to surface of the object can be transmitted through the object. In some examples, the object that is substantially transparent to light allow 60% or more, 65% or more, 70% or more, 80% or more, 85% or more, 90% or more or 95% or more of the incident light normal to surface of the object to be transmitted. In one example, the object that is substantially transparent to light allow above 70% of the incident light normal to surface of the object to be transmitted.

The term “substantially opaque to light” when used herein to describe an object is to be interpreted broadly to mean that 50% or less of the incident light normal to surface of the object can be transmitted through the object. In some examples, the object that is substantially opaque to light allow 40% or less, 35% or less, 30% or less, 20% or less, 15% or less, 10% or less or 5% or less of the incident light normal to surface of the object to be transmitted. In one example, the object that is substantially transparent to light allow below 30% of the incident light normal to surface of the object to be transmitted.

The terms “coupled” or “connected” as used in this description are intended to cover both directly connected or connected through one or more intermediate means, unless otherwise stated.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A cover lens for a display panel, said cover lens comprising:
a transparent layer; and
a mask provided on a planar surface of the transparent layer, wherein the mask is electrically conductive.

2. The cover lens according to claim 1, wherein the mask is opaque to light.

3. The cover lens according to claim 1, wherein the mask comprises a bezel provided at a periphery of the transparent layer.

4. The cover lens according to claim 3, a portion of the bezel is a first electrode layer for a piezoelectric transducer.

5. The cover lens according to claim 4, wherein the first electrode layer comprises a high temperature resilient material.

6. The cover lens according to claim 4, wherein the first electrode layer comprises one or more of conductive ceramics, metal-like carbides or nitrides, alumina-based ceramics, zirconia-based materials, silver nanowires and carbon-based conductive materials.

7. The cover lens according to claim 4, further comprising,
a piezoelectric layer provided on the first electrode layer; and
a second electrode layer provided on the piezoelectric layer, wherein the piezoelectric layer is sandwiched between the first electrode layer and the second electrode layer to form the piezoelectric transducer.

8. The cover lens according to claim 1, wherein the mask is configured to be electrically grounded.

9. A display panel comprising the cover lens of claim 1.

10. A method of fabricating a cover lens for a display panel, the method comprising:
providing a transparent layer; and
forming a mask on a planar surface of the transparent layer;
wherein the mask is electrically conductive.

11. The method according to claim 10, wherein the mask is opaque to light.

12. The method according to claim 10, wherein the mask is printed on the cover lens.

13. The method according to claim 10, wherein the mask is a bezel at a periphery of the transparent layer.

14. The method according to claim 13, wherein a portion of the bezel is a first electrode layer suitable for a piezoelectric transducer, said first electrode layer comprises a high temperature resilient material.

15. The method according to claim 14, further comprising:
forming a piezoelectric layer on the first electrode layer; and
forming a second electrode layer on the piezoelectric layer;
wherein the piezoelectric layer is sandwiched between the first electrode layer and the second electrode layer to form the piezoelectric transducer.

16. The cover lens according to claim 2, wherein the mask comprises a bezel provided at a periphery of the transparent layer.

17. The cover lens according to claim 5, wherein the first electrode layer comprises one or more of conductive ceramics, metal-like carbides or nitrides, alumina-based ceramics, zirconia-based materials, silver nanowires and carbon-based conductive materials.

18. The method according to claim 11, wherein the mask is printed on the cover lens.
